(19) United States
(12) Patent Application Publication
(10) Pub. No.: US 2026/0238753 A1
(43) Pub. Date: Aug. 13, 2026

(54) METHOD AND SYSTEM FOR AUTOMATING CAMERA MAINTENANCE OPERATIONS

(71) Applicant: VIDETICS SAS, Biot (FR)

(72) Inventors: Pierre-Alexis Le Borgne, Antibes (FR); Alexandre Reboul, Mouans-Sartoux (FR); Hedi Aloui, Vallauris (FR)

(21) Appl. No.: 19/154,109

(22) PCT Filed: Jan. 26, 2024
(86) PCT No.: PCT/EP2024/051960

§ 371 Date: Aug. 6, 2025

(30) Foreign Application Priority Data
Feb. 6, 2023 (FR) 2301100

(51) Int. Cl. H04N 17/00; H04N 7/06; H04N 7/08; H04N 7/18

(52) U.S. Cl. CPC H04N 17/002; H04N 7/066; H04N 7/0806; H04N 7/181

(57) ABSTRACT

A computer-implemented method for processing a data stream using an activated data processing system, the data processing system being adapted for the creation of a plurality of broadcast channels so as to allow the circulation of data streams within the data processing system.

### FIELD OF THE INVENTION

The invention relates to the field of video surveillance, also known as “video protection”. The invention relates more specifically to a method and system for automating camera maintenance operations, said cameras belonging to a closed-circuit television (CCTV) system.

### PRIOR ART

Today, globally, the total number of cameras installed in cities and within private facilities is more than 770 million.

Such a multitude of cameras requires a very large amount of human resources, in particular technicians, tasked with carrying out technical maintenance on each of these cameras.

Therefore, in order to control the costs associated with the number of technicians dedicated to carrying out technical maintenance on a camera network, managers or end users of closed-circuit television systems are forced to use a limited number of cameras. The limitation on the number of cameras used is therefore imposed for budgetary reasons, to the detriment of the security of the geographical site in question. Indeed, a limited number of cameras does not make it possible to ensure optimum video surveillance of a given geographical site.

The prior art contains some solutions based on intelligent video analysis (IVA) methods and systems.

These intelligent video analysis solutions make it possible to automate the use of videos captured by cameras deployed within a closed-circuit television system, and thus reduce the human resources required to analyze said videos in order to determine whether the camera is operational and is working correctly.

Thus, thanks to the existence of these automatic analysis solutions, managers or end users of closed-circuit television systems are no longer forced to limit the number of cameras in order to carry out video surveillance of specific infrastructures, such as a city or a private domain.

However, existing intelligent video analysis methods and systems do not make it possible to optimize maintenance operations carried out on cameras used for video surveillance.

Indeed, some intelligent video analysis systems are able to adjust the focal length of a determined camera in order to eliminate problems related to camera calibration and to the lack of sharpness of captured videos when the camera is installed on the geographical site in question. However, this type of adjustment must be triggered manually by a technician on each new camera that is installed.

There are also some methods for performing recurring checks on multiple cameras in order to analyze the videos captured by these cameras. However, these checks are based on unreliable technologies, such as image analyses based on image difference and pixel motion. These analyses are sensitive for example to movements of dynamic objects such as people and vehicles, to the presence of insects on the lens, to movements of trees, in particular due to wind, etc. In addition, some analyses are sensitive to sudden changes in illumination, such as the occurrence of a reflection, or continuous changes in illumination caused for example by the change in position of the Sun. These known types of technologies lead to a lack of robustness and therefore reliability of the video analysis system associated with these methods. In addition, these recurring checks are scheduled manually and allow only one type of technical failure to be evaluated. Such solutions are admittedly able to generate alert reports on the end user's system. However, producing these alert reports requires a large number of calculations and, therefore, results in a considerable loss of time and significant financial loss.

Such methods and systems therefore cannot be used, efficiently and economically, to carry out video surveillance of infrastructures comprising a large number of cameras to be used.

There are other video analysis methods and systems for predicting maintenance operations. This type of solution makes it possible to schedule the replacement of one or more technical parts before this part causes a technical failure of the camera.

However, such solutions are limited to an intrinsic failure of the camera, and cannot provide data concerning the overall working condition of the camera. Indeed, maladjustment of a parameter of the camera does not depend on the use thereof, and therefore cannot be predicted using current predictive maintenance techniques. These solutions may require an entire camera to be replaced or video surveillance continuity to be interrupted in order to replace the parts in question.

In addition, in the context of a large network of cameras, maintenance operations are carried out on the cameras on a random basis. Thus, for a specific camera, potential malfunctions and technical problems are generally detected and resolved only when this camera is being used during video surveillance.

The solutions from the prior art therefore do not make it possible to optimize maintenance operations carried out on cameras used for video surveillance, either because of the high cost that these solutions entail or because of the inadequate practical aspect of said maintenance operations.

There is therefore a need to propose new technical solutions that make it possible to ensure high-quality video surveillance with a suitable number of cameras, while at the same time optimizing the costs related to the maintenance operations carried out on these cameras.

### OBJECT OF THE INVENTION

The present invention aims to address the abovementioned need. A first subject of the present invention thus relates to a computer-implemented method for processing a data stream by way of an activated data processing system, said data processing system being designed to create a plurality of broadcast channels in order to allow a data stream to circulate within said data processing system, each broadcast channel comprising an input connector and an output connector, said method comprising the following steps:
the data processing system receiving a data stream analysis request,
determining the number of broadcast channels available within said data processing system,
if the number of available broadcast channels is greater than zero, creating at least one additional broadcast channel comprising an input connector and a first and second output connector,
transmitting the data stream to be analyzed to the input connector of the additional broadcast channel,
the data processing system processing the data stream,
disconnecting the input connector and the first output connector of the additional broadcast channel,
transmitting the processed data stream to the second output connector of the additional broadcast channel,
   such that disconnecting the input connector and the first output connector of the additional broadcast channel does not cause deactivation of the data processing system.

According to one embodiment of the invention, the step of determining the number of channels available within said data processing system comprises:
determining a total number of broadcast channels available within said data processing system for processing data streams;
determining the number of broadcast channels in the data processing system that are busy processing data streams; and
determining the number of channels available for data processing by subtracting the number of busy channels from the total number of available channels.

According to one embodiment of the invention, the step of creating said at least one additional broadcast channel comprises:
creating an additional broadcast channel with an input connector and an output connector;
connecting a TEE to the output connector of the additional broadcast channel so as thus to create the first and second output connectors.

According to one embodiment of the invention, the method furthermore comprises:
disconnecting the input connector and the first output connector of the additional broadcast channel;
increasing the number of available channels by one unit.

According to one embodiment of the invention, the method furthermore comprises:
determining the number of broadcast channels available within said data processing system;
if no broadcast channel is available, adding the data stream analysis request to a waiting list.

According to one embodiment of the invention, the step of adding the analysis request to a waiting list comprises:
adding a property to the data stream analysis request associated with the processing priority of the request over other data stream analysis requests.

According to one embodiment of the invention, the method furthermore comprises:
transmitting the data stream analysis request to said data processing system by way of an orchestration system, wherein said orchestration system provides instructions to said data processing system concerning the analysis of the data and the type of processing to be performed.

According to one embodiment of the invention, the method makes it possible to determine the operating state of at least one camera, said camera being designed to capture at least one video stream comprising a set of data, said video stream relating to a determined area, and said camera also being designed to transmit said video stream to said activated data processing system, said method comprising the following steps:
receiving a video stream analysis request,
capturing a determined number of video streams,
determining the number of available broadcast channels,
determining the effective number of video streams able to be transmitted within the available broadcast channels, said effective number of video streams corresponding to the number of available broadcast channels,
activating the input and output connectors of each available broadcast channel,
adding a second output connector for each available broadcast channel,
transmitting the effective number of video streams to the input connector of each available broadcast channel, each input connector receiving a video stream,
processing the video streams.

A second subject of the invention relates to a computer program product comprising instructions that, when the program is executed by a computer, cause said computer to implement the method described above.

A third subject of the invention relates to a computer-readable recording medium comprising instructions that, when they are executed by a computer, cause said computer to implement the method described above.

A fourth subject of the invention relates to a system for processing data streams, comprising a data processing system, said data processing system being designed to receive the data in the form of separate broadcast channels, each broadcast channel having an input connector associated with the input of data into the broadcast channel and the output connector associated with the output of data from the broadcast channel, said system furthermore comprising:
a receiver for receiving a data processing request,
a scheduler for identifying the number of broadcast channels available for data processing,
a load management system for distributing processing requests optimally according to the occupancy states of the waiting lists associated with their broadcast channels,
an orchestration system for creating, when at least one broadcast channel is available, an additional broadcast channel comprising a first input connector and a first output connector,
   wherein the orchestration system is configured to create a second output connector for the additional broadcast channel in order to be able to disconnect the first input connector and the first output connector of the additional broadcast channel without causing deactivation of the data processing system.

### BRIEF DESCRIPTION OF THE DRAWINGS

The aims, subjects and features of the invention will become more clearly apparent upon reading the following description with reference to the figures, in which:

FIG. 1 shows a diagram of an automation system, according to one embodiment of the invention;

FIG. 2 shows a diagram of the data processing system, according to one embodiment of the invention;

FIG. 3—page 1 shows the first part of a diagram relating to an automation method, according to one embodiment of the invention; and

FIG. 3—page 2 shows the second part of said diagram relating to an automation method, according to one embodiment of the invention.

### DETAILED DESCRIPTION OF THE INVENTION

The following detailed description aims to present the invention in a sufficiently clear and complete manner, in particular with the aid of examples, but should in no case be regarded as limiting the scope of protection to the particular embodiments and examples presented below.

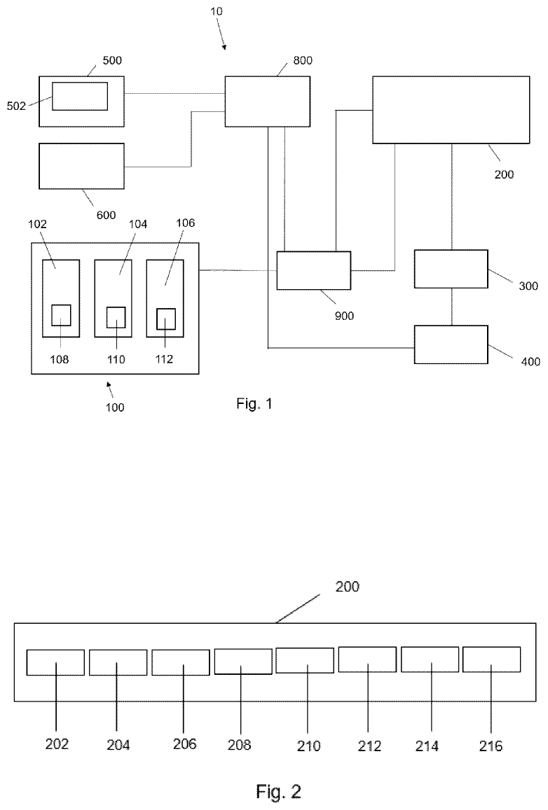

FIG. 1 shows an automation system 10 for automating camera maintenance operations, according to one embodiment of the invention.

### Automation System

The automation system 10 comprises an acquisition system 100, a data processing system 200, a communication system 300, an alert system 400, a scheduling system 500, an analysis request system 600, a load management system 800 and an orchestration system 900.

### Acquisition System

The acquisition system 100 makes it possible to acquire data, more specifically video streams. The acquisition system 100 comprises one or more cameras 102, 104, 106 designed to capture video streams. For the sake of clarity, the number of cameras 102, 104, 106 shown in FIG. 1 is limited to 3. In practice, the number of cameras 102, 104, 106 present within the automation system 100 is unlimited. The cameras 102, 104, 106 are located at predetermined locations within a determined geographical area defined in advance by a user of the automation system 10. For example, the geographical area may be a private property comprising a dwelling and spaces outside said dwelling, the user wishing to monitor said private property by way of cameras 102, 104, 106. The cameras 102, 104, 106 operate in parallel, such that each camera 102, 104, 106 is able to capture a video stream independently of the other cameras 102, 104, 106. The cameras 102, 104, 106 are organized so as to belong to one and the same computer network. Each camera 102, 104, 106 has an IP (Internet Protocol) address that makes it possible to identify said cameras on the computer network, said computer network using the IP protocol as communication protocol. Any type of camera may be used; for example, the cameras may be directly IP or analog cameras whose stream is converted by an IP or DVR encoder.

Each camera 102, 104, 106 is provided with a video encoding device 108, 110, 112. As shown in FIG. 1, each of these video encoding devices 108, 110, 112 is integrated directly into the camera. Each camera 102, 104, 106 is responsible for encoding its own stream.

For the sake of completeness, it should be noted that an analog camera requires an external encoder that simultaneously carries out the IP transformation.

If the analog stream is not converted into an IP stream, the camera must be connected to a DVR, which is capable of interpreting an analog stream, rendering it on the network and then storing it.

The video encoding device 108, 110, 112 carries out an encoding step that makes it possible to encode the data of the captured video stream so as to allow said encoded video stream to be transmitted to a data processing system 200, detailed below, which is also present on the computer network. The video encoding device 108, 110, 112 also makes it possible to associate a plurality of initial metadata relating to the corresponding captured video stream with the encoded video stream. The initial metadata concern the operating features of the camera 102, 104, 106 that captured the video stream encoded by the video encoding device 108, 110, 112. More specifically, the initial metadata comprise three types of data. The first type of data concerns the IP address of the camera 102, 104, 106 that captured the video stream. The second type of data concerns the results of the connection test or PING (Packet Internet Groper) test concerning the connection of said camera 102, 104, 106 to the computer network. The third type of data concerns the timestamp data of the video stream currently being encoded.

The acquisition system 100 thus generates a plurality of resulting video streams from the captured video streams, each resulting video stream comprising initial metadata.

### Data Processing System

As shown in FIG. 1, the automation system 10 also comprises a data processing system 200, connected to the acquisition system 100 via an orchestration system 900. The data processing system is designed to process and analyze the data transmitted by the acquisition system 100. The data processing system 200 is generally known as a streaming pipeline.

The data processing system 200 is implemented on a programmable electronic machine, such as a computer, comprising a graphics card (not shown). The graphics card comprises a graphics processing unit (GPU). This graphics processing unit is for example a GPU processor from NVIDIA®, based on the Hopper® architecture or later than the Hopper® architecture.

The data processing system 200 is able to process data in parallel using a determined number of distribution channels. The maximum number of distribution channels available is determined by the choice of the hardware making up the data processing system 200.

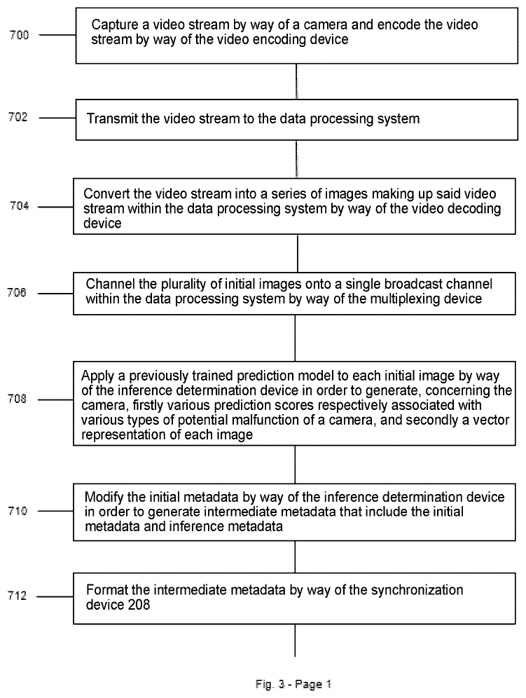

As shown in FIG. 2, the data processing system 200 comprises a plurality of components, detailed below.

### Video Decoding Device

The data processing system 200 thus comprises a decoding device 202, a multiplexing device 204, an inference determination device 206 for determining inferences concerning the operating state of a camera, a synchronization device 208, a demultiplexing device 210, an encoding device 212, a streaming device 214 and a recording on demand device 216.

The decoding device 202 comprises an electronic circuit. The decoding device 202 carries out a decoding step that makes it possible to convert a video stream captured by a camera 102, 104, 106 into a plurality of streams of initial images making up said video stream. The initial data of an initial image thus correspond to the data of the video stream to which the initial image belongs, at a determined time. For each initial image, the initial data define the content of said initial image.

### Multiplexing Device

The multiplexing device 204 comprises an electronic circuit. The multiplexing device 204 makes it possible to combine the plurality of initial image streams in series. Multiplexing is carried out by way of a muxer component running directly on the GPU, by virtue of its high parallelization capacity.

### Inference Determination Device

The inference determination device 206 runs in GPU memory and takes advantage of the large number of small processors present in a GPU card that make it possible to parallelize all similar operations via the use of Compute Unified Device Architecture (CUDA) operations. The inference determination device 206 makes it possible to predict a potential degraded operating state of one or more cameras. The inference determination device 206 makes said prediction by applying an inference process to the plurality of initial images. The application of the inference process comprises applying a specific prediction model. The specific prediction model is a model for determining an operating state of a camera applied to the plurality of initial images associated with the camera 102, 104, 106 in question. The determination model is a deep-learning neural network model that has been previously trained and validated with training images relating to correct and degraded operating states of at least one camera designed to capture video streams of a geographical area monitored by said at least one camera.

The purpose of the inference determination device 206 is to detect the potential existence of various types of malfunction of the camera 102, 104, 106 by applying the model for determining an operating state of a camera to a plurality of initial images associated with a determined camera 102, 104, 106.

The various types of malfunction comprise degraded operating states of the acquisition system 100. Degraded operating states may be generated by causes extrinsic to the acquisition system 100 or by causes intrinsic to the acquisition system 100, as detailed below.

Causes extrinsic to the acquisition system 100 may comprise, for example and without limitation, the causes listed below:
First extrinsic cause: the lens of the camera 102, 104, 106 is partially or completely obstructed by an element external to the camera 102, 104, 106.

In this situation, if the lens of the camera 102, 104, 106 is partially obstructed, the camera 102, 104, 106 incorrectly captures the video stream of the geographical area to be monitored by said camera 102, 104, 106. As an alternative, if the lens of the camera is completely obstructed, the camera 102, 104, 106 does not capture any video stream concerning the geographical area to be monitored by said camera 102, 104, 106. It is obvious that this cause must be detected as soon as possible in order to guarantee optimal operation of the automation system 10 according to the invention.

Concerning this first cause extrinsic to the camera 102, 104, 106, the inference determination device 206 carries out the prediction step on each initial image in order to obtain a prediction score. At the end of the prediction step, whatever the value of the prediction score, the inference determination device 206 generates inference metadata and combines these inference metadata with the initial metadata associated with the initial image in question in order to obtain intermediate metadata.
Second extrinsic cause: the position of the camera 102, 104, 106 has been modified with respect to the position initially provided for said camera 102, 104, 106, by applying a physical force to the camera 102, 104, 106.

In this situation, the camera 102, 104, 106 captures a video stream that corresponds to a geographical area different from the one that said camera 102, 104, 106 is supposed to monitor. It is obvious that this cause must be detected as soon as possible in order to guarantee optimal operation of the automation system 10 according to the invention.

Concerning this second cause extrinsic to the camera 102, 104, 106, the inference determination device 206 carries out the prediction step on each initial image in order to obtain a prediction vector representation of the content of the initial image in question.

At the end of the prediction step, the inference determination device 206 generates inference metadata and combines these inference metadata with the initial metadata associated with the initial image in question in order to obtain intermediate metadata.

Causes intrinsic to the acquisition system 100 may comprise, for example and without limitation, the causes listed below:
First intrinsic cause: the optical system of the camera 102, 104, 106 is faulty.

In this situation, the camera 102, 104, 106 generates a resulting video stream for which the quality of the content is degraded. Such a cause may for example generate a resulting video stream the content of which is blurred. The quality of the initial images generated from said resulting video stream is therefore degraded as well, thereby leading to an erroneous or even impossible prediction when the specific determination model is subsequently applied within the data processing system 200 by the inference determination device 206 detailed below. It is obvious that this cause must be detected as soon as possible in order to guarantee optimal operation of the automation system 10 according to the invention.
Second intrinsic cause: during acquisition of the video stream, the lens of the camera 102, 104, 106 has been overexposed or underexposed to a light source, and the sensor controlling the light exposure of the lens is faulty.

In this situation, the camera 102, 104, 106 generates a resulting video stream for which the quality of the content is degraded. The quality of the initial images generated from said resulting video stream is therefore degraded as well, thereby leading to an erroneous or even impossible prediction when the specific determination model is applied by the inference determination device 206. It is obvious that this cause must be detected as soon as possible in order to guarantee optimal operation of the automation system 10 according to the invention.
Third intrinsic cause: following the capture of the video stream, during the step of transmitting the resulting video stream to the data processing system 200, the connection of the acquisition system 100 to the computer network was interrupted or degraded, which caused a loss of transmitted data, also known as a video codec artefact, among the data within the resulting video stream.

In this situation, the quality of the resulting video stream transmitted to the data processing system 200 is degraded, thereby leading to an erroneous or even impossible prediction when the specific determination model is applied by the inference determination device 206. It is obvious that this cause must be detected as soon as possible in order to guarantee optimal operation of the automation system 10 according to the invention.

Thus, concerning the causes intrinsic to the camera 102, 104, 106, the inference determination device 206 carries out the prediction step on each initial image in order to obtain a prediction score.

At the end of the prediction step, concerning both the extrinsic causes and the intrinsic causes, regardless of the value of the prediction score and the vector representation of the content of the various initial images in question, the inference determination device 206 generates inference metadata and combines these inference metadata with the initial metadata associated with the initial image in question in order to obtain intermediate metadata.

Within the present invention, as detailed below, specific analyses are configured by a scheduling system 500. As detailed below, an analysis and alert system 400 carries out specific analyses using the intermediate metadata generated by the inference determination device 206, with the aim of detecting the abovementioned extrinsic and intrinsic causes.

The data processing system 200 comprises a synchronization device 208 that makes it possible to apply a computer function, called a callback function, as is known from the prior art. More specifically, the synchronization device 208 may be programmed to obtain information from one of the devices 202, 204, 206, 210, 212, 214, 216 of the data processing system 200. The synchronization device 208 may thus possess data currently being processed in the data processing system 200, in a specific step of said processing of said data.

FIG. 2 shows the synchronization device 208 arranged within the data processing system 200 in such a way that the data received by the synchronization device 208 originate from the inference determination device 206.

The synchronization device 208 makes it possible to prepare and format the metadata obtained within the data processing system before transmitting the metadata to the analysis and alert system 400 via the communication system 300, in a first direction of circulation of the metadata. When the metadata come from the analysis and alert system 400 via the communication system 300, in a second direction of circulation of the metadata, the synchronization device 208 receives and formats said metadata before transmitting said metadata to the demultiplexing device 210, detailed below. The synchronization device 208 may also aggregate and prepare requests from the alert system, in particular recording orders when said alert system detects a degraded operating state of the acquisition system 100.

The data processing system 200 also comprises a demultiplexing device 210. The demultiplexing device 210 makes it possible to separate the plurality of image streams analyzed by the analysis and alert system 400 and transmitted by said alert system 400 via the communication system 300.

The data processing system 200 also comprises a video encoding device 212. The encoding device 212 carries out an encoding step that makes it possible to encode the data of the image streams analyzed and transmitted by the analysis and alert system 400 via the communication system 300. The video encoding device 212 thus makes it possible to group together the analyzed images in order to reconstruct the various video streams such as those initially transmitted by the acquisition system 100 and each containing a plurality of images. The difference between the initial video streams and the reconstructed video streams is that the metadata associated with the reconstructed video streams are final metadata, as detailed below within the description of the analysis and alert system 400. The final metadata consist of the combination of the intermediate metadata and the validation and alert metadata generated by the analysis and alert system 400.

The data processing system 200 comprises a streaming device 214 and a streaming device 214. These devices 214 and 216 are placed just after the encoding in the execution chain of the streaming pipeline. They differ in only one point: their purpose. Indeed, once encoding is complete, the final component of the pipeline is either a broadcasting component displaying the stream at an address in the network where the various clients are able to connect to view the stream (streaming), or a component directing the video stream to a destination file, thereby recording the video stream in said file.

### Communication System

The automation system 10 comprises a communication system 300 for interfacing the data processing system 200, by way of the synchronization device 208 located within said data processing system 200, and the analysis and alert system 400.

The communication system 300 makes it possible to transmit in series, that is to say successively, the initial image streams associated, respectively, with their intermediate metadata, from the synchronization device 208 to the analysis and alert system 400.

Before any transmission of a data stream to the analysis and alert system 400, the communication system 300 checks the specific analyses in order to determine whether additional analysis to be carried out by the analysis and alert system 400 is scheduled for the data stream in question. If no additional analysis is scheduled, the communication system 300 transmits only the intermediate metadata to the analysis and alert system 400. If additional analysis is scheduled, the communication system 300 transmits the intermediate metadata and the associated initial image to the analysis and alert system 400.

After the analysis step carried out by the analysis and alert system 400 on the initial image streams and their intermediate metadata, the communication system 300 makes it possible to transmit, in series, the initial image streams analyzed and associated with the validation and alert metadata generated by the analysis and alert system 400, from the analysis and alert system 400 to the synchronization device 208.

### Analysis and Alert System

The automation system 10 also comprises an analysis and alert system 400 that is connected to the data processing system 200 by way of the communication system 300.

The analysis and alert system 400 makes it possible to perform two different kinds of analysis on the data streams previously processed by the data processing system 200, as detailed below in the section relating to the scheduling system 500.

The analysis and alert system 400 is based on a computer programming method carried out in Python (registered trademark) language. Once the metadata and possible images have been received via the communication system 300. The system 400 parallelizes the processing of the various streams received. Each stream is processed as follows:
aggregation+spatiotemporal stabilization of metadata,
execution of additional analyses (if scheduled),
generation of statistical content,
generation of alert content (if alert logic is active).

Once these steps have been performed in parallel for all video streams, the analysis and alert system 400 stores all of the metadata along with the generated alert content and statistical content in a database. If alert content has been generated, the analysis and alert system 400 makes a video recording request, which will be taken into account directly by the recording device 216.

The aggregated, stabilized and supplemented metadata are then returned by the analysis and alert system 400 to the communication system 300, so as then to be sent to the synchronization device 208.

### Scheduling System

The automation system 10 also comprises a scheduling system 500, which comprises a scheduling database 502. The scheduling system 500 carries out three different functions.

As shown in FIG. 1, the scheduling system is connected to the data processing system 200 via a load management system 800 and an orchestration system 900. As explained in more detail below, the load management system 800 receives instructions from the scheduling system 500 comprising for example the number of broadcast channels needed to process the video streams. In turn, the load management system 800 sends instructions to an orchestration system 900, comprising for example the address of the camera with which the video stream was obtained, the analysis time and the type of analysis to be performed using the data processing system 200.

The scheduling database 502 does not contain any notion relating to load management, and therefore to queues. More generally, the system 500 does not evaluate the load of the system 200. This is done by the load management system 800. The system 800 therefore manages waiting lists and transmits information relating to a particular analysis, upon demand from the orchestration system 900.

The scheduling database 502 contains configuration data of the data processing system 200 concerning past configurations and configurations currently being used. In addition, the scheduling database 502 comprises analysis request logs and any change applied to scheduling. The scheduling database 502 also comprises the start and end times of processing carried out by the data processing system 200 and the allocation channel in question.

The first function of the scheduling system 500 is to program the data processing system 200 by carrying out the following steps:
initializing primitives,
defining the number of available channels, this number being limited by hardware computing capacity, allowing video streams or image streams to circulate simultaneously within the data processing system 200,
creating the number of inputs and outputs of the data processing system 200 according to the previously defined number of available channels,
adding a separation component, generally called a TEE plug-in. Within the data processing system 200, the separation component makes it possible to create one or more parallel broadcast channels, at the output of the demultiplexing device 210, in order to divert the analyzed initial image stream from the demultiplexing device 210 to a parallel broadcast channel.

Thus, by placing the separation component at the output of the demultiplexing device 210, the video stream may be disconnected and the buffer may be emptied in the parallel broadcast channel, independently from the demultiplexing device 210, that is to say without any consequence on the operation of the demultiplexing device 210, which is then isolated. As is known, when a data stream is disconnected from a demultiplexing device and the buffer of said demultiplexing device is emptied, the data processing system to which the demultiplexing device belongs must be restarted before transmitting a subsequent data stream to said demultiplexing device.

However, within the present data processing system 200, the presence of the separation component at the output of the demultiplexing device 210 makes it possible to avoid systematically restarting the data processing system 200 insofar as the subsequent data stream is transmitted to the demultiplexing device 210 and said subsequent data stream replaces the previous data stream, which is still present in the demultiplexing device 210, by overwriting it. Not restarting the demultiplexing device 210 thus makes it possible to avoid a considerable loss of time, if considering a large number of video streams to be processed within the automation system 10. Therefore, advantageously, the data processing system 200 makes it possible to process video streams captured by the acquisition system 100 continuously, without loss of time.

The data stream is processed in parallel in a certain number of broadcast channels. As a general rule, each broadcast channel is associated with an input connector and an output connector. As explained above, when a data stream is disconnected from a demultiplexing device and the buffer of said demultiplexing device is emptied, this disconnection creates an error. For this reason, data processing in the entire data processing system to which the demultiplexing device belongs is interrupted, and the system has to be restarted before transmitting a subsequent data stream to said demultiplexing device.

According to the invention, each broadcast channel is associated with a first output connector and a second output connector.

This means that a distribution channel is created between an input connector and an output connector. The term pin is generally used to refer to such connectors. In addition, a second output connector is created simultaneously for example via a TEE. This means that the TEE is provided with a first and second output connector.

The advantage of these measures is that, when a data stream is disconnected, the input connector and the first output connector are disconnected, the state of the second output connector remaining unchanged. Therefore, the occurrence of an error is avoided and data processing is not interrupted, because it is not necessary to restart the system after each disconnection of a stream. The advantage of these measures is that, in practice, there is greater flexibility in terms of adding and removing broadcast channels without interrupting the processing of data streams.

It is specified that “primitives” are the components and variables of the data processing system 200 that are required for said data processing system 200 to operate correctly and that, for the most part, will remain constant throughout the lifetime of the pipeline.

Initializing these “primitives” comprises, without being limited to: initializing the inference components (model, model calibration files, etc.), initializing variables of the callback 208, etc.

The second function of the scheduling system 500 is managing the data streams circulating within the data processing system 200 by carrying out the following steps:
receiving a specific analysis request to analyze a video stream via a third-party system such as a user interface associated with the automation system 10, or such as an external system belonging to the user of the automation system 10,
ensuring that the video streams are processed within the data processing system 200 within optimized periods in order to avoid loss of time, and efficiently, that is to say taking into account the maximum processing capacity of the graphics processing unit of the graphics card used.

The third function of the scheduling system 500 is organizing the performance of the specific analyses of the video streams within the data processing system 200 in order to synchronize the removal of a video stream at the output of the data processing system 200 and the addition of a video stream at the input of the data processing system, by carrying out the following steps:

### A—Request to Process a Video Stream:

1) if at least one channel is available, the scheduling system 500 schedules a request to process a video stream as follows:
   adding said video stream at the input of the data processing system 200,
   connecting the input connector of the available channel,
   adding an output connector on the parallel broadcast channel previously created by the separation component at the output of the demultiplexing device 210.
2) if no channel is available, the scheduling system 500 schedules a request to process a video stream as follows:
   searching for and selecting the waiting list comprising the smallest number of pending processing requests,
   adding the request to process said video stream to said waiting list.

The scheduling system 500 thus provides a dynamic synchronization function.

### B—Processing Video Streams Within the Data Processing System:

1) if the waiting list contains at least one request to process a video stream:
   at the end of the processing of an existing video stream, within the data processing system 200 and in a determined channel, the data processing system 200 operates as follows:
   selecting a processing request registered in the non-empty queue of said determined channel, said selected processing request comprising, as registration date, the oldest date among the processing requests in said queue, using the FIFO (first-in first-out) principle;
   starting processing of a video stream subsequent to the previous video stream that has finished being processed, said subsequent video stream being associated with the selected processing request. The data processing system 200 thus starts the processing of the subsequent video stream as soon as the previous video stream has finished being processed and continuously. This feature of continuity means that the data processing system 200 processes the various video streams without any discontinuity of operation, that is to say without any waiting period and, more specifically, without disconnecting the input and output connections of said data processing system 200;
   updating the referencing of the channel in question, in order to register the subsequent video stream as a video stream currently being processed in the data processing system.

This solution has a particularly advantageous technical effect in particular in that no delay is generated. Indeed, in the event of replacing one stream with another (when the queue is not empty), no disconnection is performed.
2) if the waiting list does not contain a request to process a subsequent video stream:
   disconnecting the input “connector” of the channel in question in order to remove the video stream that has just finished being processed,
   disconnecting the output on the additional broadcast channel previously created by the separation component and emptying the buffer.

The scheduling system 500 may be programmed in advance by way of a third-party system such as a user interface, said user interface being associated with the automation system 10, by way of an application programming interface (API). The scheduling system 500 may also be programmed in advance by way of a third-party software system such as a virtualization platform, in particular such as a VM (virtual machine) hypervisor that communicates with the scheduling system 500 by way of an application programming interface (API).

If a stream is disconnected and were not to be replaced (if no analysis is queued), the following two acceptable choices are available:
1) it is possible to overwrite the stream in the broadcast channel with a black (empty) image, thus ensuring relatively low resource consumption on the part of the inference determination device 206. The output connector is not reconnected after the TEE. In the case of a subsequent reconnection, new overwriting is carried out, as explained above, and the output connector is reconnected.
2) it is possible to disconnect the input connector on the multiplexer side, and then to empty the buffer and disconnect the output connector after the TEE. In the case of a subsequent reconnection, the input and output connectors are reconnected after the TEE.

The first choice has the advantage of ease of orchestration, and better fluidity than reconnecting a stream. With regard to the second choice, this has the advantage of even further optimized resource use. These two types of operation may be envisaged, and may depend in particular on the preferences of the user.

The scheduling database 502 comprises configuration data of the data processing system 200 concerning past configurations and configurations currently being used. The scheduling database 502 also comprises analysis request logs and any changes applied to scheduling. The start and end times of processing carried out by the data processing system 200 and the allocation channel are contained in the scheduling database 502. The scheduling system 500 has read and write access to the scheduling database system 502. Each waiting list comprises data identifying the video stream to be analyzed and the content of said video stream to be analyzed. The waiting lists are not stored in the database. Only the execution and scheduling order are stored, the waiting lists being built dynamically according to the request (scheduled or not) and computing capacity.

As mentioned above, among the various functions carried out by the scheduling system 500, the latter manages, for each video stream, the data relating to the analyses to be performed by the analysis and alert system 400 on these video streams.

The analyses to be performed may be of three different types, as described below.

The first type of analysis concerns specific analyses. Specific analyses are analyses defined and recorded in the scheduling database 502. The specific analyses comprise applying the inference process to the initial image streams within the data processing system 200. The specific analyses comprise subsequently applying an aggregation and stabilization process to the intermediate metadata generated by the inference determination device 206 within the analysis and alert system 400 in order to determine whether the intermediate metadata are representative of a malfunction of one or more cameras 102, 104, 106 belonging to the acquisition system 100.

The aggregation process is also applied to the prediction vector representations of the content of the various initial images in question, said prediction vector representations being contained in the intermediate metadata. The aggregation process thus makes it possible to compare the prediction vector representations with reference vector representations specific to each camera 102, 104, 106 in question in order to obtain a distance between the representations. This distance value represents the value of the offset between the image of the video stream analyzed in real time and the reference frame that the system must approach in order to remain in working order.

The stabilization process makes it possible to validate the inference scores obtained over time, following the processing of the initial image streams by the inference determination device 206 within the automation system 10. Indeed, as is known, the sought causes of malfunctions are constant over time, insofar as these causes require human intervention on the cameras in question. The stabilization process therefore makes it possible to check whether an obtained inference score is reliable over time. All of the scores and vector representations transmitted to the analysis and alert system 400 are tracked using a tracking process specific to each stream, stabilizing the results over time, thereby making it possible to avoid in particular false positives (false alerts).

The second type of analysis concerns additional analyses carried out only within the analysis and alert system 400 on an optional basis. The additional analyses concern computer vision analysis. The additional analyses concern in particular the detection of a partial or generalized dynamic colorimetric imbalance within the initial images present within the captured video stream. Such a color imbalance may generate spots of various shapes that are visible on the initial images.

The third type of analysis concerns a network analysis, performed by the analysis and alert system 400 on the results of the connection test, or PING (Packet Internet Groper) test, previously carried out within the acquisition system 100 for the camera associated with the initial images. Network analysis makes it possible to detect an anomaly concerning the computer network used by the acquisition system 100. For example, an anomaly may correspond to a value resulting from the PING test greater than a determined threshold value concerning said computer network. It should be noted that network analysis does not require images, unlike the second type of analysis.

At the end of the specific analyses, the analysis and alert system 400 generates final metadata. These final metadata are considered to be valid and reliable within the automation system 10.

After having applied the aggregation and stabilization processes, the analysis and alert system 400 carries out processing aimed at comparing the aggregated and stabilized results with thresholds.

The values of each prediction score are compared with a previously determined threshold value for said prediction score concerning the sought cause of malfunction. When the value of the prediction score is greater than said threshold value, this means that the operating state of the camera 102, 104, 106 associated with said initial image is degraded.

If the distance values between the vector representations of the real-time streams and the reference streams are greater than a previously determined threshold value for said comparison indicator concerning the cause of malfunction relating to the movement of a camera, this means that the camera 102, 104, 106 associated with the initial image in question has been moved.

Exceeding a threshold value causes an alert to be generated, and this alert is therefore stored in the database. A video recording request is therefore issued and taken into account by the system 216.

Report generation may be governed by a schedule, or may be performed in real time if configured as such. In any case, for the sake of consistency, the report generation system retrieves the alerts directly from the database and issues reports.

The analysis and alert system 400 also generates statistical data, concerning the values and distance between the vector representation and their evolution over time. This makes it possible to obtain an overview of the evolution of the state of the camera over time.

The API transmits the generated alert reports to the user interface associated with the automation system 10, or to the third-party software system that requested a direct analysis request from the direct analysis request system 600, or to the third-party electronic system that requested a direct analysis request from the direct analysis request system 600.

### Load Management System

Taking into account the information available via the scheduling, the processing channel allocated to an analysis request may be set in advance and therefore stored in the scheduling database 502. However, the capacity of the load management system 800 to process spontaneous analysis requests, and therefore to optimize load distribution for each processing channel in real time, means that a set allocation of a processing channel to a scheduled analysis is optional.

The load management system 800 constructs a queue for each processing channel and fills it in response to the analysis requests provided by the scheduling system 500 (even if the analysis requests do not have an allocation channel, the load distribution is carried out automatically based on the current occupancy level of the queues).

In addition, the load management system 800 sends the information relating to the oldest analysis request in a corresponding queue (based on the FIFO (first-in first-out) principle) to a processing channel, based on the requests made by the orchestration system 900.

The load management system 800 sends information relating to the analysis requests at the end of the queue to the system 400, so that the latter prepares its aggregation and stabilization processes that will be used when the system 400 receives the intermediate metadata from 300 corresponding to the current processed stream.

### Orchestration System

The orchestration system 900 is in charge of synchronizing the input and output connectors of the processing system 200 via disconnection/connection of the input connector and via disconnection of the additional output connector. The orchestration system 900 is therefore also responsible for stopping one analysis or replacing it with another once the analysis period has elapsed within the processing system 200. It relies on the load management system 800 to retrieve the information specific to an analysis that is to be launched.

### Direct Analysis Request System

The automation system 10 also comprises a direct analysis request system 600, which is able to transmit analysis requests from a third-party system (not shown) to the load management system 800 to be executed or placed in a queue. The direct analysis request system 600 therefore operates as an interface between said third-party system, independent of the automation system 10, and the load management system 800.

The third-party system may comprise a third-party software system. The third-party software system allows a third-party scheduling system hosted by a virtualization platform such as a hypervisor or VMS (video management system) to transmit analysis requests directly to the direct analysis request system 600. The third-party software system is able to communicate with the direct analysis request system 600 over a computer network, by way of an IP (Internet Protocol) address specific to said third-party software system.

The third-party system may also comprise a third-party electronic system such as a home automation system, a robotic system, an alarm system, a technical building management system (BMS) or centralized technical management (CTM) system. The third-party electronic system is able to communicate with the direct analysis request system 600 either by way of electronic connections using GPIO (general-purpose input/output) ports or over a computer network using an electronic acquisition module such as an ADAM (registered trademark) module associated with a communication protocol such as the Modbus (registered trademark) communication protocol with a client/server architecture.

### Automation Method

If considering use of the automation system 10, this implies that the acquisition system 100, comprising one or more cameras 102, 104, 106, is installed within a geographical area subject to video protection. In addition, the automation system 10 must understand analysis requests previously defined in the scheduling system 500 or direct analysis requests transmitted to the direct analysis request system 600.

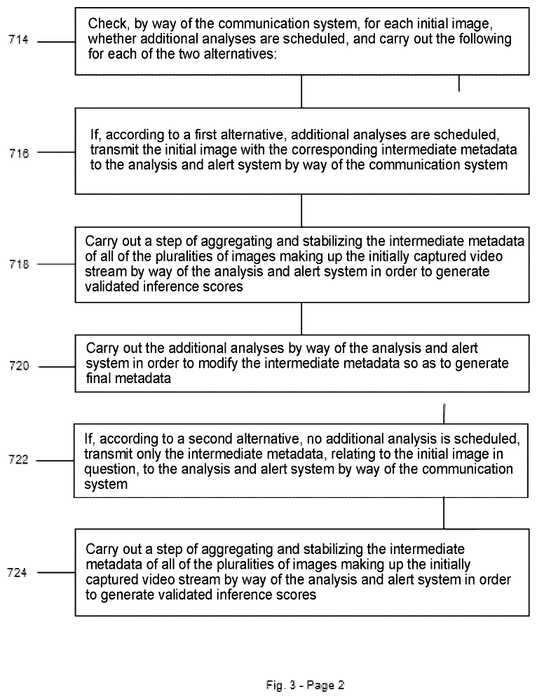

Next, when an analysis to be performed is triggered, the automation method according to the invention comprises the following steps shown in FIG. 3.

Thus, in a first step 700, the acquisition system 100 captures a video stream by way of the camera 102. Next, the video encoding device 108 associated with the camera 102 encodes the captured video stream and associates initial metadata with said video stream.

In a step 702, the acquisition system 100 transmits the video stream comprising the initial metadata to the data processing system 200.

In a step 704, within the data processing system 200, the video decoding device 202 converts the video stream into a series of images, and therefore a single image at a time T, which make up said video stream.

In a step 706, the multiplexing device 204 channels the plurality of initial images onto a single broadcast channel within the data processing system 200. This makes it possible to group together reception channels into a single broadcast channel, thus allowing parallelized processing of all of the images at a time T of all of the video streams by the inference determination device 206.

In a step 708, the inference determination device 206 applies a previously trained prediction model to each initial image in order to generate, concerning the camera 102, firstly various prediction scores respectively associated with various types of potential malfunction of a camera, and secondly a vector representation of each image. At the end of this step 708, the inference determination device 206 modifies the initial metadata in order to generate intermediate metadata, which include the initial metadata and inference metadata.

In a step 710, the synchronization device 208 formats the intermediate metadata.

In a step 712, the communication system 300 checks, for each initial image, whether additional analyses are scheduled, and carries out the following for each of the two alternatives:
if, according to a first alternative, additional analyses are scheduled, then, in a step 714, the communication system 300 transmits the initial image with the corresponding intermediate metadata to the analysis and alert system 400. Next, in a step 716, the analysis and alert system 400 carries out a step of aggregating and stabilizing the intermediate metadata of all of the pluralities of images making up the initially captured video stream in order to generate validated inference scores. In a subsequent step 718, the analysis and alert system 400 carries out the additional analyses in order to modify the intermediate metadata so as to generate final metadata.
if, according to a second alternative, no additional analysis is scheduled, then, in a step 720, the communication system 300 transmits only the intermediate metadata, relating to the initial image in question, to the analysis and alert system 400. In a subsequent step 722, the analysis and alert system 400 carries out a step of aggregating and stabilizing the intermediate metadata of the images making up the initially captured video stream in order to generate validated inference scores.

The automation system 10 and the automation method according to the invention enable cyclic checking, by way of automated rounds of surveillance, of the operating state of a network of cameras for the purpose of maintaining said cameras. The automation system 10 and the automation method according to the invention make it possible to cover a plurality of camera malfunctions, such as those generally listed in the prior art concerning video protection.

In addition, the use of deep-learning neural network models enables the automation system 10 and the automation method according to the invention to guarantee continuity of performance of the analyses that are performed and a high level of relevance of the alerts that are generated, and therefore of the reports that are generated.

Furthermore, the automation system 10 and the automation method according to the invention make it possible to optimize human rounds of surveillance carried out by a maintenance team. Indeed, by virtue of the automation system 10 and the automation method according to the invention, multiple automated rounds of surveillance may be scheduled by way of the scheduling system 500, considering for example permanent priorities or seasonal priorities, while at the same time retaining the possibility of triggering a one-off analysis request concerning a specific camera.

Implementing automated rounds of surveillance and other one-off analysis requests makes it possible, by virtue of the automation system 10 and the automation method according to the invention, to obtain either real-time alert reports or operational reports with a periodicity determined by the maintenance team. The alerts may for example result in the triggering of a visual or audible alert on the third-party system of maintenance staff, the arming of a procedure of calibrating and correcting the hardware responsible for the incident, or the changing of the display of video streams in the VMS. If the malfunction is a result of a continuous maladjustment of the parameters of the sensor, a calibration and correction procedure may correct the problem.

For the display of streams in the VMS, this means that, if an alert is generated for a particular video stream, said stream may be displayed in real time on the VMS.

In practical terms, the use of the automation system 10 according to the invention allows a maintenance team to intervene on a specific basis. Indeed, after receiving an operational report, maintenance staff are able to determine whether said operational report indicates malfunctioning of one or more cameras. If this is the case, this means that human intervention is necessary to carry out a maintenance operation on the one or more cameras with degraded operation.

The maintenance team may thus easily include the maintenance operation to be performed in the usual intervention planning in order to schedule said maintenance operation.

The automation system 10 and the automation method according to the invention therefore allow a maintenance team made up of a few people to manage, efficiently and at lower cost, a geographical area the dimensions of which involve the installation of a hundred or so cameras, for example, to provide video protection for said geographical area. Indeed, the automation system 10 and the automation method make it possible to avoid a significant increase in the human resources needed to perform monitoring and maintenance operations on a video protection system when the dimensions of the geographical areas to be monitored increase inordinately.

The embodiments described above are indicated solely by way of example.

1.-11. (canceled)

12. A computer-implemented method for processing data streams by way of an activated data processing system, the data processing system being configured to create a plurality of broadcast channels to allow a data stream to circulate within the data processing system, each broadcast channel comprising an input connector and an output connector, the method comprising the following steps:
receiving, by the data processing system, a data stream analysis request;
determining a number of available broadcast channels within the data processing system;
if the number of available broadcast channels is greater than zero, creating at least one additional broadcast channel comprising an input connector and first and second output connectors;
transmitting a data stream to be analyzed to the input connector of the additional broadcast channel;
processing the data stream by means of the data processing system;
disconnecting the input connector and the first output connector of the additional broadcast channel; and
transmitting the processed data stream to the second output connector of the additional broadcast channel;
wherein disconnecting the input connector and the first output connector of the additional broadcast channel is such as not to cause deactivation of the data processing system.

13. The method according to claim 12, wherein the step of determining the number of available broadcast channels within the data processing system comprises:
determining a total number of available broadcast channels within the data processing system for processing data streams;
determining a number of busy broadcast channels in the data processing system that are busy processing data streams; and
determining the number of available broadcast channels for data processing by subtracting the number of busy broadcast channels from the total number of available broadcast channels.

14. The method according to claim 12, wherein the step of creating said at least one additional broadcast channel comprises:
creating an additional broadcast channel with an input connector and an output connector; and
connecting a TEE to the output connector of the additional broadcast channel so as to thereby create the first and second output connectors.

15. The method according to claim 12, further comprising:
increasing the number of available channels by one unit after disconnecting the input connector and the first output connector of the additional broadcast channel.

16. The method according to claim 12, further comprising:
if no broadcast channel is available in response to determining the number of available broadcast channels within the data processing system, adding the data stream analysis request to a waiting list.

17. The method according to claim 16, wherein the step of adding the analysis request to a waiting list comprises:
adding a property to the data stream analysis request associated with a processing priority of the data stream analysis request over other data stream analysis requests.

18. The method according to claim 12, further comprising:
transmitting the data stream analysis request to the data processing system by way of an orchestration system, wherein the orchestration system provides instructions to the data processing system concerning analysis of the data stream and a type of processing to be performed.

19. The method according to claim 12, the method allowing determination of an operating state of at least one camera, the at least one camera being configured to capture at least one video stream comprising a set of data, the video stream relating to a determined area, and the camera also being configured to transmit the video stream to the activated data processing system, the method comprising the following steps:
receiving a video stream analysis request;
capturing a determined number of video streams;
determining the number of available broadcast channels;
determining the effective number of video streams able to be transmitted within the available broadcast channels, the effective number of video streams corresponding to the number of available broadcast channels;
activating the input and output connectors of each available broadcast channel;
adding a second output connector to each available broadcast channel;
transmitting the effective number of video streams to the input connector of each available broadcast channel, each input connector receiving a video stream; and
processing the video streams.

20. A computer program product comprising instructions that, when the program is executed by a computer, cause the computer to implement the method according to claim 12.

21. A computer-readable recording medium comprising instructions that, when they are executed by a computer, cause the computer to implement the method according to claim 12.

22. A system for processing data streams, comprising a data processing system, the data processing system being configured to receive data in the form of separate broadcast channels, each broadcast channel having an input connector associated with the input of data into the broadcast channel and an output connector associated with the output of data from the broadcast channel, the system further comprising:
a receiver for receiving a data processing request;
a scheduler for identifying a number of available broadcast channels available for data processing;
a load management system for distributing data processing requests optimally according to occupancy states of waiting lists associated with the broadcast channels; and
an orchestration system for creating, when at least one broadcast channel is available, an additional broadcast channel comprising a first input connector and a first output connector, wherein the orchestration system is configured to create a second output connector for the additional broadcast channel in order to allow disconnection of the first input connector and the first output connector of the additional broadcast channel without causing deactivation of the data processing system.
